(19) United States
(12) Patent Application Publication
(10) Pub. No.: US 2008/0298073 A1
(43) Pub. Date: Dec. 4, 2008

(54) LIGHTING SYSTEM

(75) Inventor: Shi Hwa HUANG, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: OMT Digital Display Technology(ShenZhen) Limited, Shenzhen (CN)

(21) Appl. No.: 11/877,996

(22) Filed: Oct. 24, 2007

(30) Foreign Application Priority Data
May 28, 2007 (CN) 200710074628.6

(51) Int. Cl. F21V 13/04

(52) U.S. Cl. 362/308

(57) ABSTRACT

The invention discloses a lighting system which includes a light source (11), a lens group (12) and an aspherical reflector (13). The light source includes an elliptical reflection cover (111). A light beam emitting from the light source is focused on an entry of the lens group via the elliptical reflection cover. The lens group regulates the light beam to a round patch and then which is projected onto the aspherical reflector. The aspherical reflector changes the round patch to an inverse trapezia patch. Then the inverse trapezia patch can be projected on an object (14) and become a large square patch in a short distance. The utilization efficiency of the light energy is enhanced in the lighting system, and the lighting system includes a small number of components, uses the point light source, and becomes easy to produce, and convenient to repair.

### FIELD OF THE INVENTION

This invention relates to lighting field, and particularly to a lighting system for the area light source with equal light beams and high utilization efficiency of light energy, which is preferably used in a LCD lighting system.

### BACKGROUND OF THE INVENTION

The flat LCD requires a lighting system for an area light source, the traditional lighting system for the area light source is roughly divided into direct lighting system and side lighting system. The direct light system includes ten linear light source placed below a diffusion slice, although this system is better in the equalization of the screen brightness, its weakness is the increased power consumption. In addition, the side light system includes about one or two lamp tubes placed at one end, which is used to change the linear light source into the flat light source. This system reduces the amount of the lamp tube, so it can reduce the power and reduce the thickness of the light source, however, because the light source is placed on one side, the screen brightness is not equal.

The above-described side source system is required to receive the light from the lamp tube on the end side, and change it into the light guide plate of the flat light source; equalize the light of the flat light source as the diffusion board; focus the beam to the panel in order to enhance the brightness as sawtooth lens loop. As described in the Japan patent JP-A2000-147497, the devices such as light guide plate, diffusion board, and sawtooth lens loop are assembled in the stacking mode, because the panel assembly is complicated in this method, so it requires much time and high cost. In addition, because the air with low reflective index exists between the above layers, so the reflective index of the light is high on this interface, the projected light will reduce, and the utilization efficiency of the light power is not high.

Otherwise, the traditional linear light source system includes the Hg and will lead to some pollution to the environment.

### SUMMARY OF THE INVENTION

The purpose of the present invention is to change a small patch to a large square patch via a series of the optical transforms in a lighting system.

One embodiment of the present invention provides a lighting system which comprises a light source, a lens group and an aspherical reflector. The light source comprises an elliptical reflection cover. A light beam emitting from the light source is focused on an entry of the lens group via the elliptical reflection cover. The lens group regulates the light beam to a round patch and then which is projected onto the aspherical reflector. The aspherical reflector changes the round patch to an inverse trapezia patch. Then the inverse trapezia patch can be projected on an object and become a large square patch in a short distance. The object is often a flat object.

Alternatively, the inverse trapezia patch can be any patch which is larger at the top and smaller at the bottom, such as an inverse triangle. Then a large square patch can be achieved after the small patch which is larger at the top and smaller at the bottom is projected.

The light source can be selected from an elliptical lamp, a paraboloid lamp, a LED lamp or a laser.

An optical tube or an Fly Eye Lens can be arranged between the light source and the lens group to obtain patch.

In another embodiment of the present invention, a small reflector is disposed between the lens group and the aspherical reflector, the small reflector and the flat object form a L-shaped light channel.

In another embodiment of the present invention, a big reflector is disposed between the flat object and the aspherical reflector. The big reflector may be a big aspherical reflector.

In another embodiment of the present invention, a polarization conversion device is disposed between the light source and the lens group to change the light beam to P polarization type light beam.

In the above embodiments of the present invention, the light beam projected on the lens group is located below the central line a-a of the lens group; the small patch projected on the aspherical reflector is located above the central line a-a of the lens group; the larger patch formed on the flat object is located above the central line a-a.

In the above embodiments of the present invention, the reflection angle λ from the lens group to the object via the aspherical reflector is from 0° to 90°. If the reflection angle λ is smaller, the light beam from the bottom of the small patch is projected to the bottom of the large patch on the object; if the reflection angle is bigger, the light beam from the top of the small patch is projected to the top of the large patch on the object.

In another embodiment of the present invention, the object may comprises a sawtooth lens array. The sawtooth lens array comprises a plurality of sawtooth lens loops with same center, and each sawtooth lens loop has an inner wall and an outer wall; the sawtooth lens array has an upper area and a lower area, wherein the upper area corresponds to the light beam with bigger reflection angle λ, the lower area corresponds to the light beam with smaller reflection angle λ, the light beam with bigger reflection angle λ enters into the inner wall of the sawtooth lens loop and emits on the outer wall as a result of total reflection; the light beam with the smaller reflection angle λ reaches the outer wall of the sawtooth lens loop and emits as a result of refraction.

In another embodiment of the present invention, an antireflection film may be arranged on the inner wall to enhance the utilization efficiency of the light energy.

In the above embodiments of the present invention, the lighting system can be applied in a flat LCD. A beam splitter is arranged in front of the lighting system in the flat LCD.

The advantages of this invention comprise:

Because the reflection method is utilized for projection, the utilization efficiency of the light energy is enhanced;

Because the polarization light beam is utilized for light beam output, the efficiency of the light passing the LCD is high;

This invention comprises a small number of components, uses the point light source, and becomes easy to produce, and convenient to repair.

### BRIEF DESCRIPTION OF THE DRAWINGS

FIG. 1 is a schematic view of a lighting system in accordance with first preferred embodiment of the present invention;

FIG. 2 is a schematic view of a lighting system in accordance with second preferred embodiment of the present invention;

FIG. 3 illustrates a patch projection location in FIG. 2;

FIG. 4 illustrates a mapping relation of the distribution of the reflection angle λ and the trapezia patch;

FIG. 5 illustrates a mapping relation of the distribution of all points of the reflection angle λ and the large square patch;

FIG. 6 is a schematic view of the flat object 14 of the light system;

FIG. 7 is a structural illustration of a lighting system in accordance with third preferred embodiment of the present invention;

FIG. 8 is a structural illustration of a lighting system in accordance with forth preferred embodiment of the present invention;

FIG. 9 is a structural illustration of a lighting system in accordance with fifth preferred embodiment of the present invention; and

FIG. 10 is a structural illustration of a lighting system in accordance with sixth preferred embodiment of the present invention;

### DETAILED DESCRIPTION OF THE INVENTION

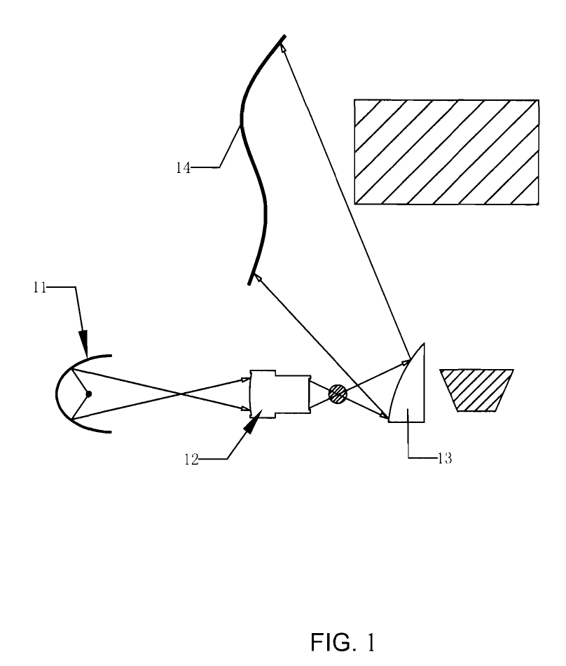

As shown in the FIG. 1, a lighting system in accordance with first preferred embodiment of the present invention comprises a light source 11, a lens group 12 and an aspherical reflector 13. The light source 11 comprises an elliptical reflection cover 111. A light beam emitting from the light source 11 is focused on an entry of the lens group 12 via the elliptical reflection cover 111. The lens group 12 regulates the light beam to a round patch and then which is projected onto the aspherical reflector 13. The aspherical reflector 13 changes the round patch to an inverse trapezia patch. Then the inverse trapezia patch can be projected on an object 14 and become a large square patch in a short distance. The object 14 is often a flat object.

Alternatively, the inverse trapezia patch can be any patch which is larger at the top and smaller at the bottom, such as an inverse triangle. Then a large square patch can be achieved after the small patch which is larger at the top and smaller at the bottom is projected.

The light source 11 can be selected from an elliptical lamp, a paraboloid lamp, a LED lamp or a laser.

An optical tube or an Fly Eye Lens can be arranged between the light source and the lens group to obtain patch.

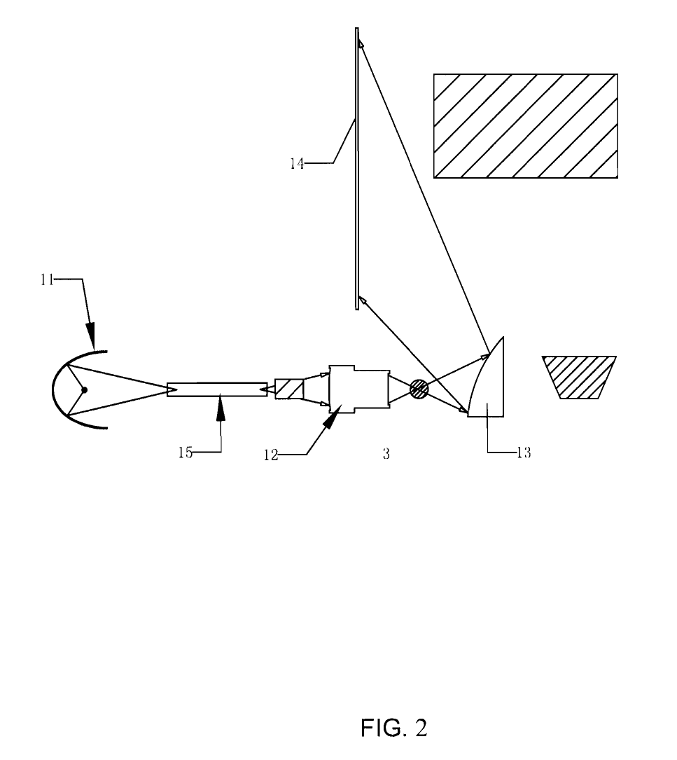

Referring to FIG. 2, a lighting system in accordance with second preferred embodiment of the present invention is shown. The lighting system further comprises a square optical tube 15 disposed between the light source 11 and the lens group 12. The light beam from the light source 11 is projected to the square optical tube 15 to form a small square patch; the small square patch is forwarded into the lens group 12. The lens group 12 regulates the small square patch to a round patch and then which is projected onto the aspherical reflector 13. The aspherical reflector 13 changes the round patch to an inverse trapezia patch. Then the inverse trapezia patch can be projected on the object 14 and become a large square patch in a short distance.

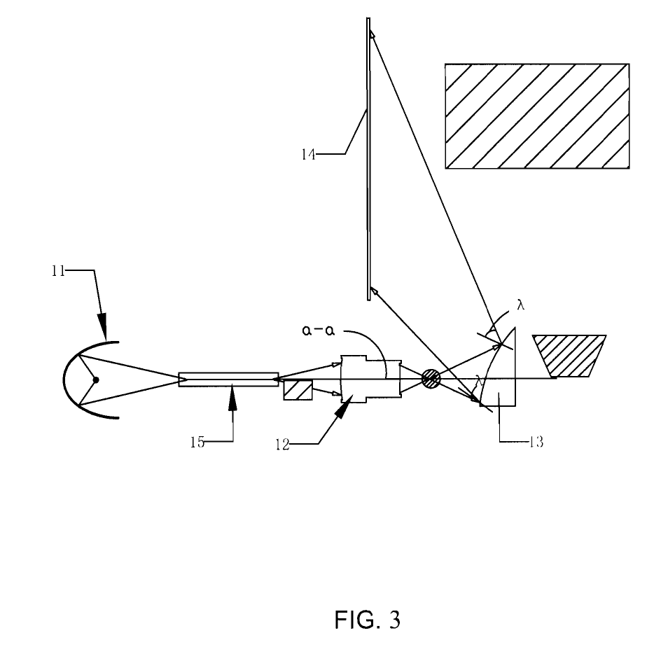

The FIG. 3 illustrates the patch projection location in the above preferred embodiments. The above-described small square patch is located below the central line a-a of the lens group 12; the inverse traperzia patch formed by the aspherical reflector 13 is located above the central line a-a of the lens group 12; the large square patch formed on the object 14 is located above the described central line a-a. The round patch is projected to the aspherical reflector 13, and the reflection angle λ on the object 14 is from 0° to 90°, wherein, if the reflection angle λ is smaller, the light beam from the bottom of the traperzia patch is projected to the patch bottom on the object 14; if the reflection angle is bigger, the light beam from the top of the traperzia patch is projected to the patch top on the flat object 14, the object 14 may be a flat LCD.

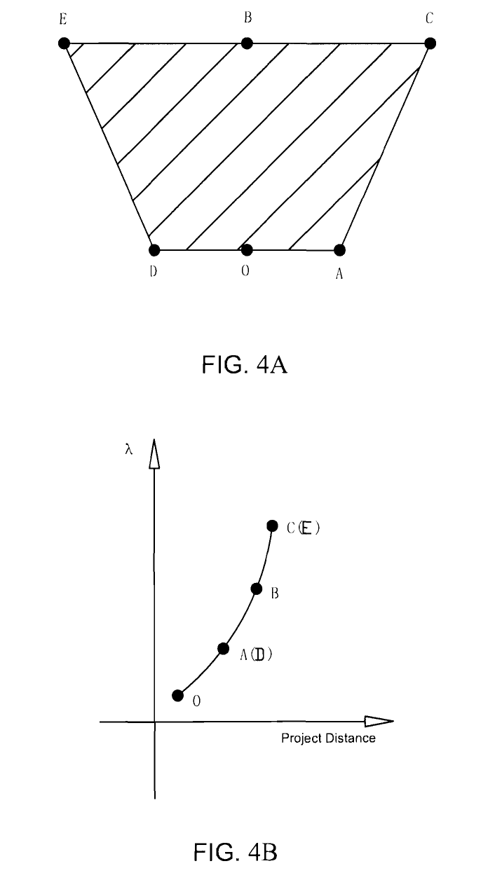

To further understand the mapping relation of the distribution of the reflection angle λ and trapezia patch, as shown in the FIG. 4A; the bottom of the inverse trapezia patch comprises a bottom central point O, a first end point D and a second end point A; the top of the inverse trapezia patch comprises a top central point B, a third end point E and a fourth end point C; the corresponding reflection λ of these points are shown in FIG. 4B; the bottom central point O is the central point of the coordinate axis, with the increase of the distance to the central point O, the point A(D), point B and point C(E) is arrayed in turn, their corresponding reflection angle λ shows incremental relation. The left points and right points with same distance to the central points such as A and D have the same reflection angle λ.

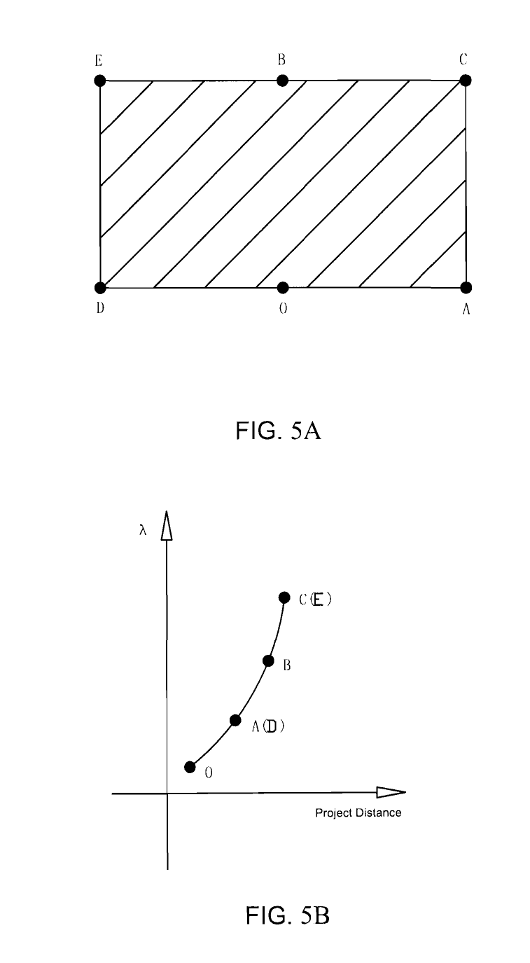

Similarly, to understand the mapping relation of all points of the reflection angle λ and the large square patch, as shown in the FIG. 5A, the large square patch comprises a bottom central point O′, a first end point D′ and a second end point A′; the top of the large square patch comprises a top central point B′, a third end point E′ and a fourth end point C′; the corresponding reflection λ of these points are shown in FIG. 5B; the bottom central point O′ is the central point of the coordinate axis, with the increase of the distance to the central point O′, the point A′(D′), point B′ and point C′(E′) is arrayed in turn, their corresponding reflection λ shows incremental relation. The left points and right points with same distance to the central point, such as A′ and D′, have the same reflection angle λ.

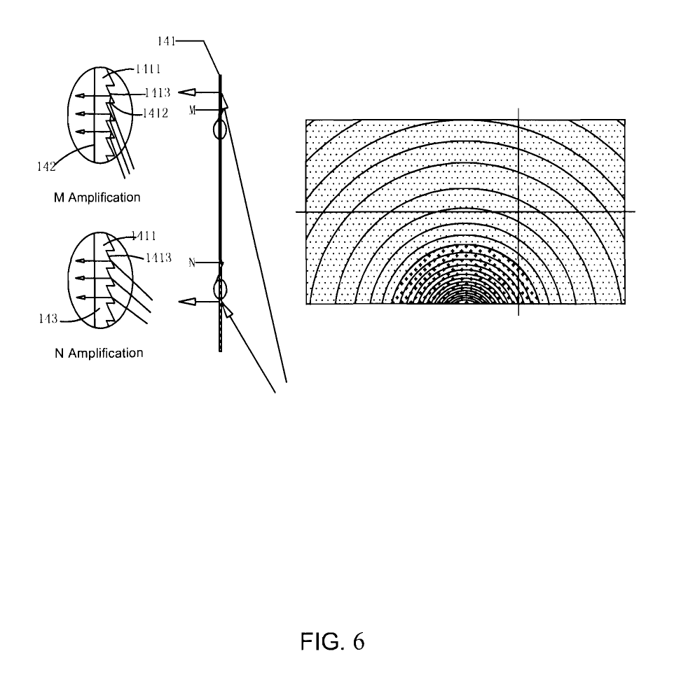

As shown in the FIG. 6, the object 14 may comprise a sawtooth lens array 141 on one side thereof. The sawtooth lens array 141 comprises a plurality of sawtooth lens loops 1411 with same center. Each sawtooth lens loop 1411 is tiny transparent prismatic lens. Each sawtooth lens loop 1411 has an inner wall 1412 and an outer wall 1413. The central light beam of all points on the large square patch with different direction can be regulated to a horizontal light beam via the sawtooth lens array 141. The sawtooth lens array 141 has an upper area 142 and a lower area 143. The upper area 142 corresponds to the light beam with bigger reflection angle λ. The lower area 143 corresponds to the light beam with smaller reflection angle λ. The light beam with bigger reflection angle λ enters into the inner wall 1412 of the sawtooth lens loop 1411 and emits on the outer wall 1413 as a result of total reflection, therefore, the procedure improves the utilization efficiency of the light energy. An antireflection film may be arranged on the inner wall 1412 to enhance the utilization efficiency of the light energy. Because the lower area 143 corresponds to the light beam with the smaller reflection angle λ, the light beam with the smaller reflection angle λ reaches the outer wall 1413 of the sawtooth lens loop 1411 and emits as a result of refraction.

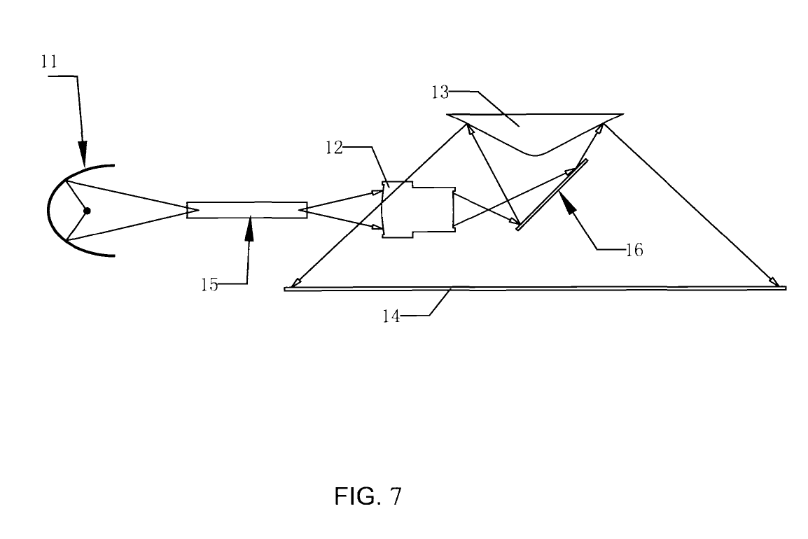

The FIG. 7 is a structural illustration of a lighting system in accordance with third preferred embodiment of the present invention. To make this lighting system more compact in structure, it comprises the light source 11, the lens group 12, the aspherical reflector 13 and a small reflector 16, wherein, the light beam emitted from the light source 11 is focused at the entry of the lens group 12, the lens group 12 adjusts the light beam as the round patch, and the round patch is reflected to the aspherical reflector 13 via the small reflector 16; this aspherical reflector 13 changes the above round patch to an inverse trapezia patch; so it can be projected to the object 14 in a short distance and show a large square patch, wherein, the above-described small reflector 16 and the object 14 form a L-shaped light channel structure, so the structure is more compact.

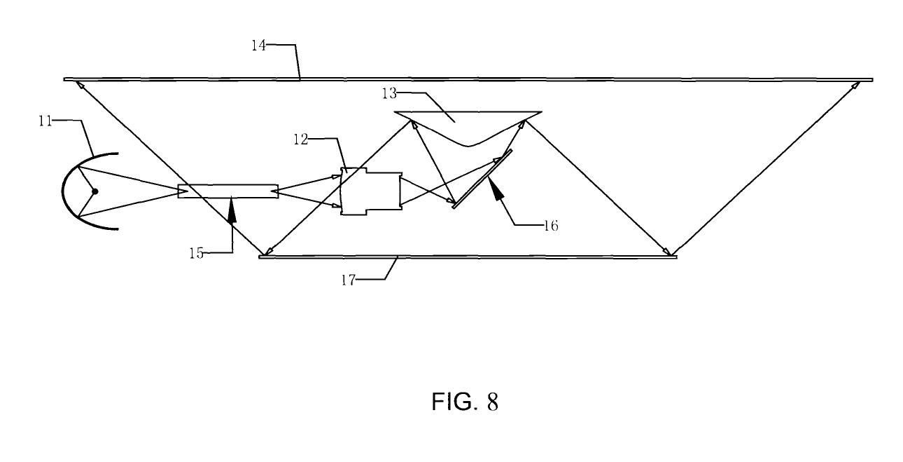

To get a larger square patch and keep its compact structure, the lighting system may also comprise fourth preferred embodiment, as shown in the FIG. 8. The lighting system comprises the light source 11, the lens group 12, the aspherical reflector 13, the small reflector 16 and a big reflector 17, wherein the light beam emitted from the light source 11 is focused at the entry of the lens group 12, the lens group 12 adjusts the light beam as the round patch, and the round patch is reflected to the aspherical reflector 13 via the small reflector 16; the aspherical reflector 13 changes the round patch as the inverse trapezia patch and projects it to the big reflector 17, finally the patch on the big reflector 17 is projected to the object 14 in a short distance and shows the larger square patch, wherein, the above-described small reflector 16 and the object 14 form the L light channel structure, the big reflector 17 is located at the top of the small reflector 16, so the structure is more compact.

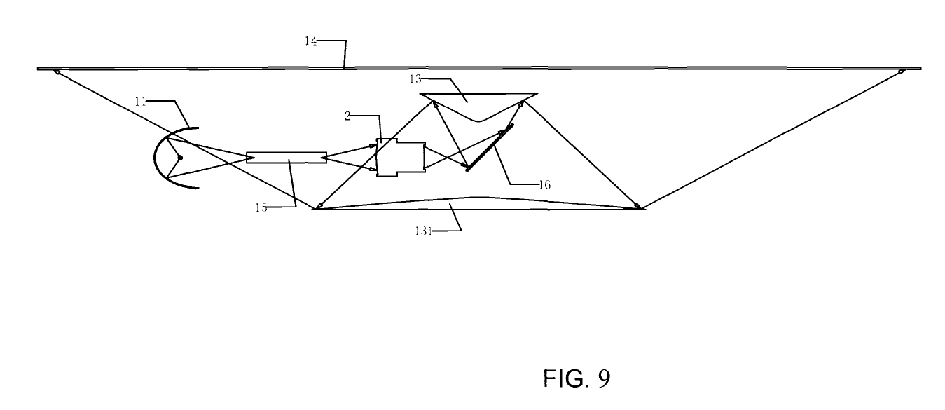

As shown in the FIG. 9, in fifth preferred embodiment the above-described big reflector 17 may also be replaced by another aspherical reflector 131.

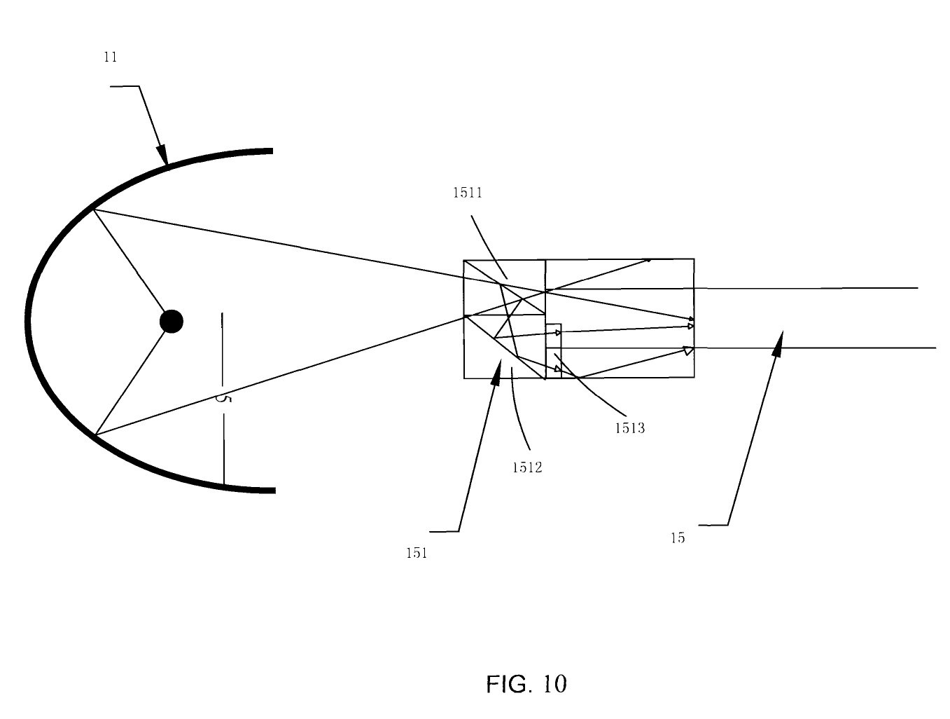

As shown in the FIG. 10, in sixth preferred embodiment a polarization conversion device 151 is located before the square light tube 15, the described polarization conversion device 151 comprises a first sawtooth lens loop group 1511 and a second sawtooth lens loop group 1512, wherein, the described first sawtooth lens loop group 1511 transmits P polarization light beam and reflects S polarization light beam to the second sawtooth lens loop group 1512, the second sawtooth lens loop group 1512 reflects S polarization light beam and penetrates a half wave slice 1513 to form P polarization light beam. The above polarization conversion device 151 changes all emitted light beam to P polarization light beam, and then the beam will enter into the square light tube 15.

This lighting system can be applied in the flat LCD TV, when it is applied in the flat LCD TV, a light splitter is placed in front of the lighting system.

The advantages of this invention comprise:

Because the reflection method is utilized for projection, the utilization efficiency of the light energy is enhanced;

Because the polarization light beam is utilized for light beam output, the efficiency of the light passing the LCD is high;

This invention comprises a small number of components, uses the point light source, and becomes easy to produce, and convenient to repair.

What is claimed is:

1. A lighting system for lighting a object, comprising:
a light source emitting a light beam,
a lens group for regulating the light beam to a small patch, and
an aspherical reflector for changing the small patch projected thereon to a larger patch projected on the object.

2. The lighting system as claimed in claim 1, wherein the small patch is larger at the top and smaller at the bottom.

3. The lighting system as claimed in claim 2, wherein the small patch which is larger at the top and smaller at the bottom may be an inverse trapezia patch.

4. The lighting system as claimed in claim 1, wherein the larger patch may be a large square patch.

5. The lighting system as claimed in claim 1, wherein an optical tube or an Fly Eye Lens may be arranged between the light source and the lens group to obtain patch.

6. The lighting system as claimed in claim 1, wherein a square optical tube is disposed between the light source and the lens group to form a small square patch.

7. The lighting system as claimed in claim 1, wherein the light source can be selected from an elliptical lamp, a paraboloid lamp, a LED lamp or a laser.

8. The lighting system as claimed in claim 1, wherein a small reflector is disposed between the lens group and the aspherical reflector, the small reflector and the flat object form a L-shaped light channel.

9. The lighting system as claimed in claim 8, wherein a big reflector is disposed between the flat object and the aspherical reflector.

10. The lighting system as claimed in claim 9, wherein the big reflector may be a big aspherical reflector.

11. The lighting system as claimed in claim 1, wherein a polarization conversion device is disposed between the light source and the lens group to change the light beam to P polarization type light beam.

12. The lighting system as claimed in claim 1, wherein the light beam projected on the lens group is located below the central line a-a of the lens group; the small patch projected on the aspherical reflector is located above the central line a-a of the lens group; the larger patch formed on the flat object is located above the central line a-a.

13. The lighting system as claimed in claim 1, wherein the reflection angle λ from the lens group to the object via the aspherical reflector is from 0° to 90°.

14. The lighting system as claimed in claim 13, wherein if the reflection angle λ is smaller, the light beam from the bottom of the small patch is projected to the bottom of the large patch on the object; if the reflection angle is bigger, the light beam from the top of the small patch is projected to the top of the large patch on the object.

15. The lighting system as claimed in claim 1, wherein the object may comprises a sawtooth lens array.

16. The lighting system as claimed in claim 15, wherein the sawtooth lens array comprises a plurality of sawtooth lens loops with same center, and each sawtooth lens loop has an inner wall and an outer wall; the sawtooth lens array has an upper area and a lower area, wherein the upper area corresponds to the light beam with bigger reflection angle λ, the lower area corresponds to the light beam with smaller reflection angle λ, the light beam with bigger reflection angle λ enters into the inner wall of the sawtooth lens loop and emits on the outer wall as a result of total reflection; the light beam with the smaller reflection angle λ reaches the outer wall of the sawtooth lens loop and emits as a result of refraction.

17. The lighting system as claimed in claim 16, wherein an antireflection film may be arranged on the inner wall to enhance the utilization efficiency of the light energy.

18. The lighting system as claimed in claim 1, wherein the lighting system can be applied in a flat LCD.

19. The lighting system as claimed in claim 18, wherein a beam splitter is arranged in front of the lighting system in the flat LCD.
